(19) United States
(12) Patent Application Publication
(10) Pub. No.: US 2016/0170981 A1
(43) Pub. Date: Jun. 16, 2016

(54) DOCUMENT ANALYSIS SYSTEM, DOCUMENT ANALYSIS METHOD, AND DOCUMENT ANALYSIS PROGRAM

(71) Applicant: UBIC, Inc., Tokyo (JP)

(72) Inventors: Masahiro Morimoto, Tokyo (JP); Hideki Takeda, Tokyo (JP); Kazumi Hasuko, Tokyo (JP)

(21) Appl. No.: 14/397,833

(22) PCT Filed: Mar. 17, 2014
(86) PCT No.: PCT/JP2014/057115

§ 371 Date: Oct. 29, 2014

(30) Foreign Application Priority Data
Sep. 5, 2013 (JP) 2013-184152

(51) Int. Cl. G06F 17/30; G06Q 30/00; G06F 3/0484; G06F 3/0481; G06F 17/24; G06F 17/27

(52) U.S. Cl. CPC G06F 17/30011; G06F 17/24; G06F 17/27; G06F 3/0484; G06F 3/0481; G06Q 30/0185

(57) ABSTRACT

A document analysis system includes an investigation basic database that stores information related to litigation or fraud investigation, an input-of-investigation category accepting unit that accepts the input of a category of the litigation or fraud investigation, and an investigation type determining unit that determines an investigation category as an investigation target based on the category accepted by the input-of-investigation category accepting unit to extract the type of necessary information from the investigation basic database.

### TECHNICAL FIELD

This disclosure relates to a document analysis system, a document analysis method, and a document analysis program.

### BACKGROUND

Conventionally, when a crime or a legal conflict related to computers such as unauthorized access or leakage of confidential information occurs, means or techniques for collecting and analyzing devices, data, or electronic records required for investigation into the cause to reveal the legal evidence thereof have been proposed.

Particularly, in a civil case in the United States, since eDiscovery (electronic discovery) is required, both the plaintiff and defendant in the case are responsible for submitting all relevant digital information. Therefore, both must submit digital information recorded in computers and servers.

However, with the rapid development and prevalence of IT, since most information is created on computers in today's business world, floods of digital information are present within the same company.

Therefore, a mistake wherein confidential digital information not necessarily relevant to the lawsuit, is included as materials submitted to the court can be made in the process of preparation work to submit those materials. The submission of confidential document information unrelated to the lawsuit has caused a problem.

In recent years, techniques related to document information in forensic systems have been proposed in Japanese Patent Application Laid-Open No. 2011-209930, Japanese Patent Application Laid-Open No. 2011-209931 and Japanese Patent Application Laid-Open No. 2012-32859. Japanese Patent Application Laid-Open No. 2011-209930 discloses a forensic system in which a specific individual is selected from at least one or more users included in user information, only digital document information accessed by the specific individual is extracted based on access history information regarding the selected specific individual, additional information indicating whether document files in the extracted digital document information are related to a lawsuit respectively is set, and a document file related to the lawsuit is output based on the additional information.

Japanese Patent Application Laid-Open No. 2011-209931 discloses a forensic system in which recorded digital information is displayed, user-specifying information, indicating to which one of users contained in user information each of multiple document files is related, is set, the set user-specifying information is set to be recorded in a storage unit, at least one or more of the users are selected, a document file in which user-specifying information corresponding to the selected user(s) is set is searched for, additional information indicating whether the searched document file is related to a lawsuit is set through a display unit, and a document file related to the lawsuit is output based on the additional information.

Japanese Patent Application Laid-Open No. 2012-32859 discloses a forensic system in which the specification of at least one or more document files included in digital document information is received, an instruction about which language a specified document file is to be translated into is received, the specified document file is translated into the instructed language, a common document file indicating the same content as the specified document file is extracted from digital document information recorded in a recording unit, the extracted common document file incorporates the translation content of the translated document file to generate translation-related information indicating that the file is translated, and a document file related to a lawsuit is output based on the translation-related information.

However, for example, the forensic systems in Japanese Patent Application Laid-Open No. 2011-209930, Japanese Patent Application Laid-Open No. 2011-209931 and Japanese Patent Application Laid-Open No. 2012-32859 are to collect vast amounts of document information on users who have used multiple computers and servers.

In classification work to determine whether the vast amounts of digitized document information are appropriate as relevant materials for legal proceedings, a user called a “reviewer” needs to classify the document information one by one while visually checking the document information, and this causes a problem that large amounts of labor and cost are required.

It could therefore be helpful to provide a document analysis system, a document analysis method, and a document analysis program to make it easy to analyze document information used in a lawsuit.

### SUMMARY

We thus provide:

The document analysis system is a document analysis system that acquires digital information recorded on multiple computers or servers, and analyzes document information included in the acquired digital information and composed of multiple documents to make easy use of the document information in litigation or fraud investigation, characterized by including: an investigation basic database for storing information related to the litigation or fraud investigation; an input-of-investigation category accepting unit for accepting the input of a category of the litigation or fraud investigation; and an investigation type determining unit for determining an investigation category as an investigation target based on the category accepted by the input-of-investigation category accepting unit to extract the type of necessary information from the investigation basic database.

The above document analysis system can further include a display screen controlling unit for controlling a display screen to present, to a user, the type of information extracted by the investigation type determining unit.

The above document analysis system can further include an input accepting unit for accepting user's input of a keyword and/or a sentence corresponding to the type of information presented to the display screen controlling unit.

The above document analysis system can further include an information extraction unit for extracting, from the investigation basic database, a keyword and/or a sentence corresponding to the type of information extracted by the investigation type determining unit.

The above document analysis system can further include a search unit for searching the documents for the keyword and/or the sentence.

The above document analysis system can further include an automatic classification code giving unit for automatically giving classification codes to the documents, wherein the keyword and/or the sentence can be used to give the classification codes.

The document analysis method is a document analysis method for acquiring digital information recorded on multiple computers or servers, and analyzing document information included in the acquired digital information and composed of multiple documents to make easy use of the document information in litigation or fraud investigation, characterized by including: an input-of-investigation category accepting step of accepting the input of a category of the litigation or fraud investigation; and an investigation type determining step of determining an investigation category as an investigation target based on the category accepted in the input-of-investigation category accepting step to extract the type of necessary information from an investigation basic database for storing information related to the litigation or fraud investigation.

The document analysis program is a document analysis program for acquiring digital information recorded on multiple computers or servers, and analyzing document information included in the acquired digital information and composed of multiple documents to make easy use of the document information in litigation or fraud investigation, characterized by causing a computer to realize: an input-of-investigation category accepting function of accepting the input of a category of the litigation or fraud investigation; and an investigation type determining function of determining an investigation category as an investigation target based on the category accepted by the input-of-investigation category accepting function to extract the type of necessary information from an investigation basic database for storing information related to the litigation or fraud investigation.

Our document analysis system, the document analysis method, and the document analysis program can make it easy to analyze document information used in a lawsuit.

### BRIEF DESCRIPTION OF THE DRAWINGS

FIG. 1 is a configuration diagram of a document discrimination system according to an example.

FIG. 2 is a chart showing a processing flow of a document analysis method according to an example.

FIG. 3 is a chart showing an investigation and classification processing flow according to the type of investigation type in a document analysis method according to an example.

FIG. 4 is a chart showing a flow of predictive coding according to the type of investigation in the document analysis method according to an example.

FIG. 5 is a chart showing a processing flow in each stage in an example.

FIG. 6 is a chart showing a processing flow of a keyword database in an example.

FIG. 7 is a chart showing a processing flow of a related term database in an example.

FIG. 8 is a chart showing a processing flow of a first automatic classification unit in an example.

FIG. 9 is a chart showing a processing flow of a second automatic classification unit in an example.

FIG. 10 is a chart showing a processing flow of a classification code accepting/giving unit in an example.

FIG. 11 is a chart showing a processing flow of a document analysis unit in an example.

FIG. 12 is a graph showing the analysis results of the document analysis unit in an example.

FIG. 13 is a chart showing a processing flow of a third automatic classification unit in one example.

FIG. 14 is a chart showing a processing flow of the third automatic classification unit in another example.

FIG. 15 is a chart showing a processing flow of a quality checking unit in an example.

FIG. 16 is a document display screen in an example.

### DESCRIPTION OF REFERENCE NUMERALS

1 document analysis system
201 first automatic classification unit
301 second automatic classification unit
401 third automatic classification unit
501 quality checking unit
601 learning unit
701 report preparation unit
100 data storage unit
101 digital information storage area
103 investigation basic database
104 keyword database
105 related term database
106 score calculation database
107 report preparation database
109 database management unit
112 document extraction unit
114 word search unit
116 score calculation unit
118 document analysis unit
120 language determination unit
122 translation unit
124 trend information generating unit
130 document display unit
131 classification code accepting/giving unit
133 lawyer's review accepting unit
11 document display screen

### DETAILED DESCRIPTION

A document analysis system will be described.

The document analysis system is a document analysis system that acquires digital information recorded on multiple computers or servers, and analyzes document information included in the acquired digital information and composed of multiple documents to make easy use of the document information in litigation or fraud investigation.

The document analysis system mentioned above includes an investigation basic database, an input-of-investigation category accepting unit, and an investigation type determining unit.

The investigation basic database stores information related to litigation or fraud investigation.

The input-of-investigation category accepting unit accepts the input of a category of litigation or fraud investigation.

The investigation type determining unit determines an investigation category as an investigation target based on the category accepted by the input-of-investigation category accepting unit, and extracts the type of necessary information from the investigation basic database.

The document analysis system can further include a display screen controlling unit that controls a display screen on which the type of information extracted by the investigation type determining unit is presented to a user.

In this case, the document analysis system can further include an input accepting unit that accepts the input of a keyword and/or a sentence from the user, which corresponds to the type of information presented by the display screen controlling unit.

The document analysis system can further include an information extraction unit that extracts, from the investigation basic database, a keyword and/or a sentence corresponding to the type of information extracted by the investigation type determining unit.

The document analysis system can further include a search unit that searches documents for the keyword and/or the sentence.

The document analysis system can further include an automatic classification code giving unit that automatically gives classification codes to the documents, and the keyword and/or the sentence can be used to give the classification codes.

Next, the details of the document analysis system will be specifically described with reference to a drawing. Note that the example to be described below is just one example, and this disclosure is not limited to this example.

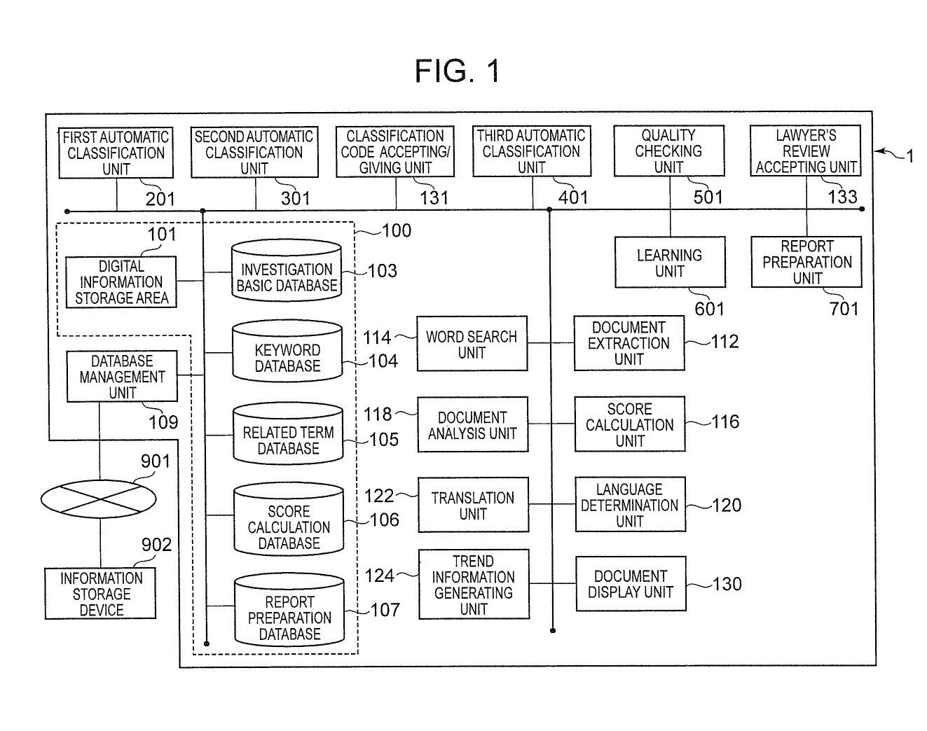

FIG. 1 shows an example of the configuration of a document analysis system.

As shown in FIG. 1, a document analysis system 1 can have a data storage unit 100 that stores information and data. The data storage unit 100 stores, in a digital information storage area 101, digital information acquired from multiple computers or servers for use in analysis of litigation or fraud investigation.

Then, the data storage unit 100 stores an investigation basic database 103 that stores, for example, a category attribute indicating to which category, litigation matters including antitrust, patent, FCPA, and PL or fraud investigation including information leak and billing fraud, data belong, a company name, a person in charge, a custodian, and the structure of an investigation or classification input screen, a keyword database 104 that registers a specific classification code for a document included in the acquired digital information, a keyword having closely connected to the specific classification code, and keyword corresponding information indicative of a correspondence relation between the specific classification code and the keyword, a related term database 105 that registers a predetermined classification code, a related term consisting of words the appearance frequencies of which are high in a document to which the predetermined classification code is given, and related term corresponding information indicative of a correspondence relation between the predetermined classification code and the related term, and a score calculation database 106 that registers the weighting of a word included in the document to calculate a score indicative of the strength of connection between the document and the classification code.

The data storage unit 100 further stores a report preparation database 107 that registers the format of a report defined according to the category, the custodian, and the contents of classification work. This data storage unit 100 may be placed inside the document analysis system 1 as shown in FIG. 1, or may be placed outside the document analysis system 1 as a separate storage device.

The document analysis system 1 includes a database management unit 109 that manages the updates of the contents of the investigation basic database 103, the keyword database 104, the related term database 105, the score calculation database 106, and the report preparation database 107.

The database management unit 109 can be connected to an information storage device 902 via a dedicated connection line or an Internet line 901. Then, the database management unit 109 can update data contents in the investigation basic database 103, the keyword database 104, the related term database 105, the score calculation database 106, and the report preparation database 107 based on the contents of data stored in the information storage device 902.

The document analysis system 1 can include a document extraction unit 112 that extracts multiple documents from document information, a word search unit 114 that searches for a keyword or a related term recorded in the databases from the document information, and a score calculation unit 116 that calculates a score indicative of the strength of connection between a document and a classification code.

The document analysis system 1 can have a first automatic classification unit 201 that searches for a keyword recorded in the keyword database 104 by the word search unit 114, extracting a document including the keyword from the document information, and automatically giving a specific classification code to the extracted document based on the keyword corresponding information, and a second automatic classification unit 301 that extracts, from the document information each of documents including a related term recorded in the related term database, calculating a score based on an evaluation value of the related term included in the extracted document and the number of appearances of the related term, and automatically giving the specific classification code to a document, the score of which exceeds a certain value among the documents including the related term, based on the score and the related term corresponding information.

Further, the document analysis system 1 can include a document display unit 130 that displays on a screen multiple documents extracted from the document information, a classification code accepting/giving unit 131 that accepts classification codes given by the user based on relevance to the litigation, to multiple documents extracted from the document information and to which no classification code is given, and giving the classification codes, a document analysis unit 118 that analyzes each document to which a classification code is given by the classification code accepting/giving unit 131, and a third automatic classification unit 401 that automatically gives classification codes to documents to which the classification codes are given by the classification code accepting/giving unit 131 among the multiple documents extracted from the document information based on the analysis results analyzed by the document analysis unit 118.

Further, the document analysis system 1 may include a language determination unit 120 that determines the kind of language of each extracted document, and a translation unit 122 that translates the extracted document when being specified by the user or automatically. The separation of language in the language determination unit 120 can be set smaller than one sentence to support a compound language case including two or more languages in one sentence. Further, processing to remove HTML headers and the like from translation targets may be performed.

Further, the document analysis system 1 may include a trend information generating unit 124 that generates trend information representing the degree of similarity of each document to a document to which a classification code is given based on the kind of word, the appearance frequency, and the evaluation value of the word included in each document to perform analysis by the document analysis unit 118.

Further, the document analysis system 1 may include a quality checking unit 501 that compares a classification code accepted by the classification code accepting/giving unit 131 with a classification code given by the document analysis unit 118 based on the trend information to verify the validity of the classification code accepted by the classification code accepting/giving unit 131.

Further, the document analysis system may include a learning unit 601 that learns the weighting of each keyword or related term based on the results of the document analysis processing.

The document analysis system 1 can include a report preparation unit 701 that outputs an optimal investigative report based on the results of the document analysis processing according to the type of investigation such as litigation matters or fraud investigation. The litigation matters include, for example, antitrust (cartel), patent, Foreign Corrupt Practices Act (FCPA), and product liability (PL). The fraud investigation includes, for example, information leak and billing fraud.

The document analysis system 1 can include a lawyer's review accepting unit 133 that accepts, for example, chief lawyer or chief patent attorney's review to improve the quality of the classification survey and report.

The following will describe terms specific to the example to facilitate understanding of the document analysis system 1.

The “classification code” means an identifier used in classifying a document, and indicates relevance to litigation to make easy use of the document in a lawsuit. For example, when document information is used as evidence in the lawsuit, the classification code may be given according to the type of evidence.

The “document” means data including one or more keywords. As an example of the “document,” e-mail, presentation materials, spreadsheet materials, meeting materials, a contract document, an organization chart, or a business plan can be cited.

The “word” means the minimum character string unit having a meaning. For example, in a sentence as “the document means data including one or more words,” the words “document,” “one,” “or more,” “words,” “including,” “data,” and “means” are included.

The “keyword” means a character string unit having a certain meaning in a language. For example, when a keyword is selected from a sentence saying “documents are classified,” the keyword can be “document” or “classification.” In the embodiment, a keyword such as “infringement,” “lawsuit,” or “Patent Publication No. xxx” is preferentially selected.

In the example, it is assumed that morphemes are included in the keywords.

Further, the “keyword corresponding information” means information representing the correspondence relation between a keyword and a specific classification code. For example, when a classification code “important” representing a document important to a lawsuit has a close connection with a keyword “infringer” in the lawsuit, the “keyword corresponding information” may be information for managing the keyword by linking the classification code “important” with the keyword “infringer.”

The “related term” means a word(s) the evaluation value of which is larger than or equal to a certain value among words the appearance frequency of which is commonly high in documents to which a predetermined classification code is given. For example, the appearance frequency means the ratio of the appearance of the related term to the total number of words in one document.

The “evaluation value” means the amount of information on each word working on in a certain document. The “evaluation value” may be calculated based on the amount of transmitted information. For example, when a predetermined trade name is given as a classification code, the “related term” may refer to the name of a technical field to which the commercial product belongs, a country of selling the commercial product, the name of a similar commercial product, or the like. Specifically, when the trade name of a device for performing an image coding process is given as a classification code, “coding process,” “Japan,” or “encoder” is cited as the “related term.”

The “related term corresponding information” means information representing the correspondence relation between a related term and a classification code. For example, when a classification code “product A” as a trade name that leads to a lawsuit has a related term “image coding” as the function of the product A, the “related term corresponding information” may mean information managing the related term by linking the classification code “product A” with the related term “image coding.”

The “score” means a value obtained by quantatively evaluating the strength of connection with a specific classification code in a certain document. In each example, the score is calculated using equation (1) from words appearing in the document and the evaluation value of each word:

Scr=Σᵢ₌₀^{N}i*(mᵢ*wgtᵢ²)/Σᵢ₌₀^{N}i*wgtᵢ² (1)

Scr: the score of the document
mᵢ: the appearance frequency of the i-th keyword or related term
wgtᵢ²: the weight of the i-th keyword or related term.

Further, the document analysis system 1 may extract a word frequently appearing in documents having a common classification code given by the user. Then, the trend information on the kind of extracted word included in each document, and the evaluation value and appearance frequency of each word may be analyzed document by document to give the common classification code to documents having the same tendency as the analyzed trend information among the documents the classification codes of which have not been accepted by the classification code accepting/giving unit 131.

The “trend information” means information representing the degree of similarity of each document to a document to which a classification code is given. The trend information is represented as the degree of relevance to a predetermined classification code based on the kind of word included in each document, the appearance frequency, and the evaluation value of the word. For example, when each document is similar to a document to which the predetermined classification code is given in terms of the degree of relevance to the predetermined classification code, it means that the two documents have the same trend information. Further, a document including a word having the same evaluation value and included in the document at the same appearance frequency even through different in the kind of word included in the document may be determined to be a document having the same tendency.

Next, a document analysis method will be described.

The document analysis method is a document analysis method that acquires digital information recorded on multiple computers or servers, and analyzing document information included in the acquired digital information and composed of multiple documents to make easy use of the document information in litigation or fraud investigation, characterized by including: an input-of-investigation category accepting step of accepting the input of the category of litigation or fraud investigation; and a investigation type determining step of determining an investigation category as an investigation target based on the category accepted in the input-of-investigation category accepting step to extract the type of necessary information from the investigation basic database to store information related to litigation or fraud investigation.

Next, the details of the document analysis method will be specifically described with reference to the accompanying drawings. Note that the example to be described below is just one example, and this disclosure is not limited to this example.

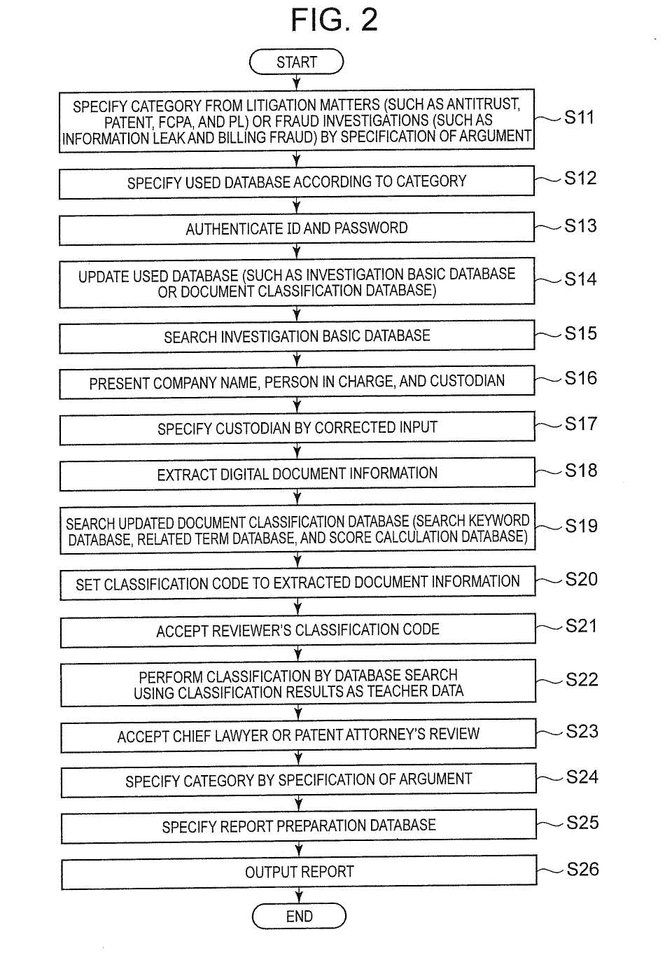

FIG. 2 shows a flowchart of the document analysis method according to the example. The example of the document analysis method will be described below with reference to FIG. 2.

The specification of an argument can be accepted from the user according to the display of a display screen on the display unit to specify a corresponding category, for example, from litigation matters including antitrust, patent, FCPA, and PL, or fraud investigation including information leak and billing fraud (S11).

According to the specified category, a used database such as the investigation basic database or the document analysis database can be specified (S12).

To check to see if the used database is the latest, access to the information storage device storing the latest database can be made. The information storage device is installed inside an organization that carries out classification or outside the organization. In the case of being installed outside the organization, the information storage device may be installed, for example, at a partner law firm or patent office.

Upon accessing the information storage device, an ID and a password can be authenticated to ensure security (S13).

After authentication, access to the information storage device is permitted to enable the used database such as the investigation basic database or the document analysis database to be updated with the latest database (S14).

The updated investigation basic database can be searched (S15) to present, to the screen of the display device, a company name, and the names of a person in charge and a custodian (S16).

When the names of the person in charge and the custodian displayed on the screen of the display device are different from the names of an actual person in charge and an actual custodian, the user corrects the names of the person in charge and the custodian on the screen of the display device. The document analysis system can accept the user's corrected input to specify the names of the actual person in charge and the custodian (S17).

Next, digital document information can be extracted to do document analysis work (S18).

The updated keyword database, related term database, and score calculation database as the updated document analysis databases can be searched (S19) to give classification codes to the extracted document information (S20).

Further, classification codes given by the reviewer can be accepted to give the classification codes to the extracted document information (S21).

The classification results can be used as teacher data to search the databases to give classification codes to the extracted document information (S22).

Chief lawyer or patent attorney's review can be accepted (S23). This can improve the investigation quality.

A category can be specified by the specification of an argument from the user (S24) to specify the report preparation database according to the specified category (S25). The format of a report can be defined according to the specified report preparation database to output the report automatically (S26).

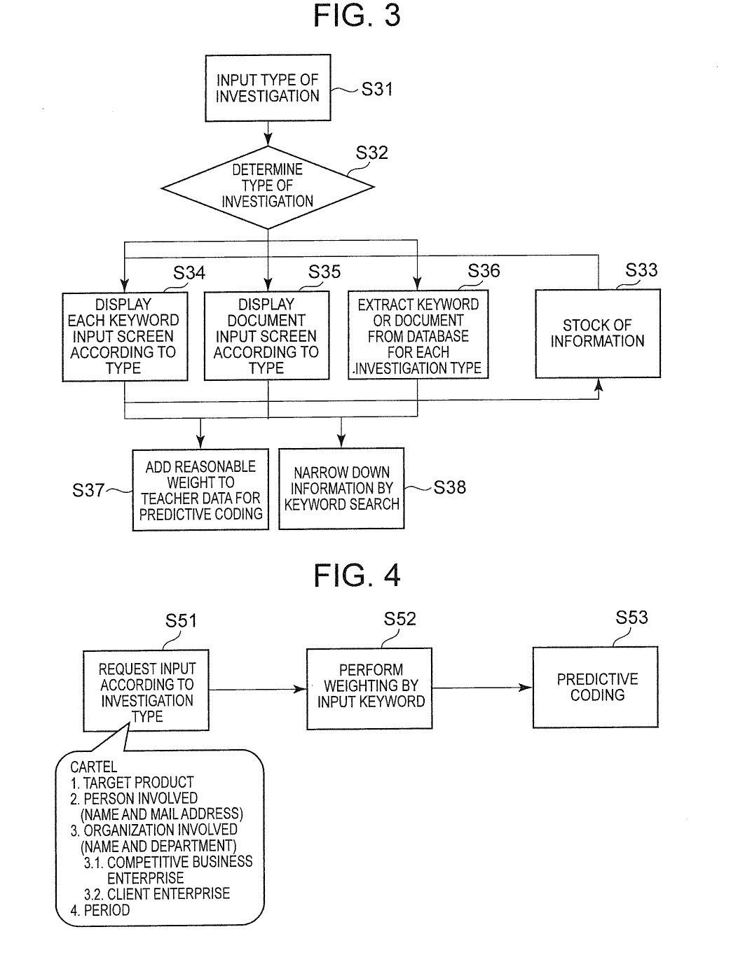

FIG. 3 is a chart showing an investigation and classification processing flow according to the type of investigation in the document analysis method according to an example.

First, the type of investigation can be input (S31). In other words, the user enters investigation and classification work to do and a corresponding category according to the display of the display screen, for example, from litigation matters, including antitrust, patent, Foreign Corrupt Practices Act (FCPA) and product liability (PL), or fraud investigation including information leak and billing fraud. The document analysis system can accept the user's input of the category to specify a category to be investigated.

According to the specified category, the type of investigation and document analysis processing and the type of database to be used can be determined (S32).

According to the specified category, access to a stock of information stored in the used database, such as the investigation basic database or the document analysis database, may be made (S33).

According to the specified category, access to the investigation basic database can be made to display each keyword input screen corresponding to the specified category (S34).

According to the specified category, access to the investigation basic database can be made to display each sentence input screen corresponding to the specified category (S35).

According to the specified category, access to the investigation basic database can be made to extract a keyword or a document corresponding to the specified category (S36).

The above-mentioned processing can be performed to add a weight to the teacher data for automatically giving classification codes (predictive coding) (S37).

A keyword search can be performed on the document analysis database to narrow down documents and information to be extracted (S38).

FIG. 4 is a chart showing a flow of predictive coding according to the type of investigation in the document analysis method according to an example.

In the document analysis method, the document analysis system can first make a request to the user for input according to the type of investigation, and accept user's input in response. For example, the document analysis system can make a request to the user for input about a cartel based on the antitrust laws, i.e., the target product, the person involved (name and mail address), the organization involved (name and department) and the period, and accept user's input in response. In regard to the organization involved, the document analysis system can request the user to enter a competitive business enterprise and a client enterprise, and accept user's input in response (S51).

Next, weighting can be performed for giving a classification code depending on the input keyword (S52). Then, predictive coding can be performed (S53).

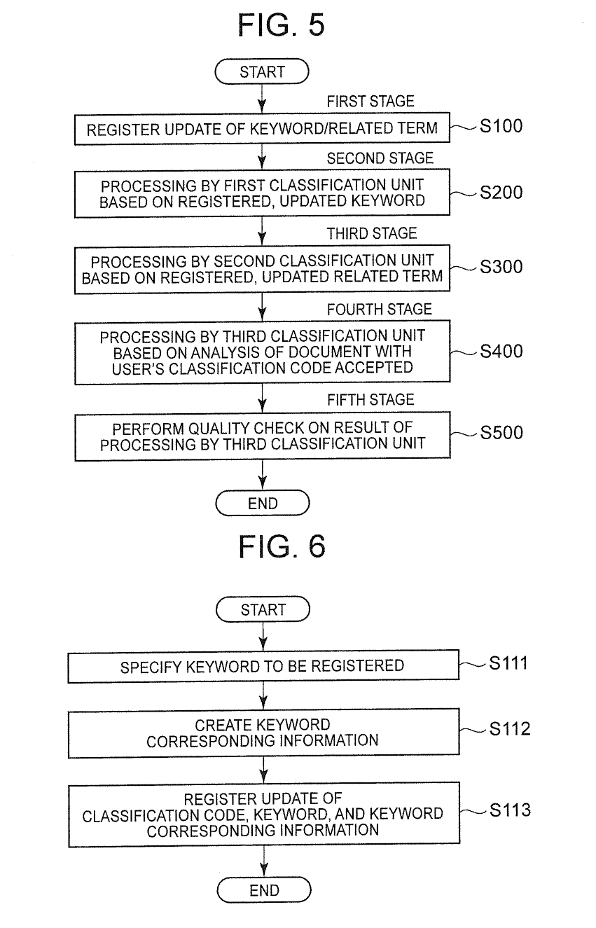

As an example, registration processing, classification processing, and check processing can be performed in a first stage to a fifth stage according to a flowchart as shown in FIG. 5.

In the first stage, the update of a keyword and a related term is pre-registered using the past results of classification processing (STEP 100). At this time, the update of the keyword and the related term is registered together with the keyword corresponding information and the related term corresponding information as correspondence information between a classification code and the keyword or the related term.

In the second stage, a document including the keyword the update of which is registered in the first stage is extracted from all pieces of document information, and when the document is found, the updated keyword corresponding information recorded in the first stage is referred to perform first classification processing to give the classification code corresponding to the keyword (STEP 200).

In the third stage, a document including the related term the update of which is registered in the first stage is extracted from document information to which no classification code is given in the second stage to calculate a score for the document including the related term. The calculated score and the related term corresponding information the update of which is registered in the first stage are referred to perform second classification processing to give the classification code (STEP 300).

In the fourth stage, classification codes given by the user to document information to which no classification code is given up to and including the third stage are accepted to give the classification codes accepted from the user to the document information. Next, the document information to which the classification codes accepted from the user are given is analyzed, and documents to which no classification code is given are extracted based on the analysis results to perform third classification processing for giving classification codes to the extracted documents. For example, words frequently appearing in documents having a common classification code given by the user are extracted, the trend information on the kind of extracted word included in each document, and the evaluation value and appearance frequency of each word is analyzed document by document to give the common classification code to documents having the same tendency as the trend information (STEP 400).

In the fifth stage, a classification code to be given, based on the analyzed trend information, to the documents to which the classification code is given by the user in the fourth stage is determined, and the determined classification code is compared with the classification code given by the user to verify the validity of the classification processing (STEP 500). Further, learning processing may be performed as needed based on the results of the document analysis processing.

The trend information used in the fourth stage and the fifth stage of processing is information representing the degree of similarity of each document to a document to which a classification code is given, which is based on the kind of word, the appearance frequency, and the evaluation value of the word included in each document. For example, when each document is similar to a document to which a predetermined classification code is given in terms of the degree of relevance to the predetermined classification code, it means that the two documents have the same trend information. Further, a document including a word having the same evaluation value and included in the document at the same appearance frequency even though different in the kind of word included in the document may be determined to be a document having the same tendency.

A detailed processing flow in each of the first stage to the fifth stage will be described below.

### First Stage (STEP 100)

A detailed processing flow of the keyword database 104 in the first stage will be described with reference to FIG. 6.

The keyword database 104 creates a table to manage each of classification codes based on the results of classifying documents for past lawsuits to specify keywords corresponding to each classification code (STEP 111). In the example, this specification is done by analyzing documents to which each classification code is given and using the appearance frequency and evaluation value of each keyword in the documents, but a method using the amount of transmitted information on each keyword or a method of selecting keywords manually by the user may be employed.

For example, when keywords “infringement” and “patent attorney” are specified as keywords of the classification code “important,” keyword corresponding information indicating that “infringement” and “patent attorney” are keywords closely connected to the classification code “important” is created (STEP 112). Then, the specified keywords are registered in the keyword database 104. At this time, the specified keywords and the keyword corresponding information are recorded in association with each other in a management table for the classification code “important” in the keyword database 104 (STEP 113).

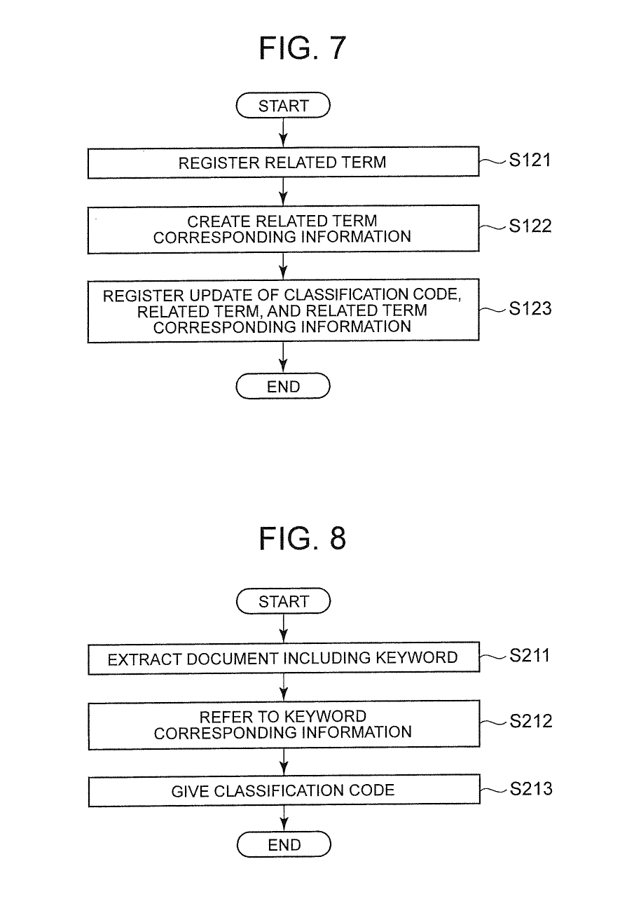

Next, a detailed processing flow of the related term database 105 will be described with reference to FIG. 7. The related term database 105 creates a table to manage each of classification codes based on the results of classifying documents for past lawsuits to register related terms corresponding to each classification code (STEP 121). For example, when “coding process” and “product a” as related terms of “product A,” and “decoding” and “product b” as related terms of “product B” are registered.

Related term corresponding information indicating to which classification code each of the registered related terms corresponds is created (STEP 122), and recorded in each management table (STEP 123). At this time, a threshold value as a score necessary to determine an evaluation value and a classification code of each related term is also recorded in the related term corresponding information.

Before doing actual classification work, the keywords and the keyword corresponding information, and the related terms and the related term corresponding information are updated with the latest ones and registered (STEP 113, STEP 123).

### Second Stage (STEP 200)

A detailed processing flow of the first automatic classification unit 201 in the second stage will be described with reference to FIG. 8. In the example, the first automatic classification unit 201 performs processing for giving the classification code “important” to documents in the second stage.

The first automatic classification unit 201 extracts documents including the keywords “infringement” and “patent attorney,” registered in the keyword database 104 in the first stage (STEP 100), from document information (STEP 211). The management table in which the keywords are recorded from the keyword corresponding information is referred (STEP 212) to give the classification code “important” to the extracted documents (STEP 213).

### Third Stage (STEP 300)

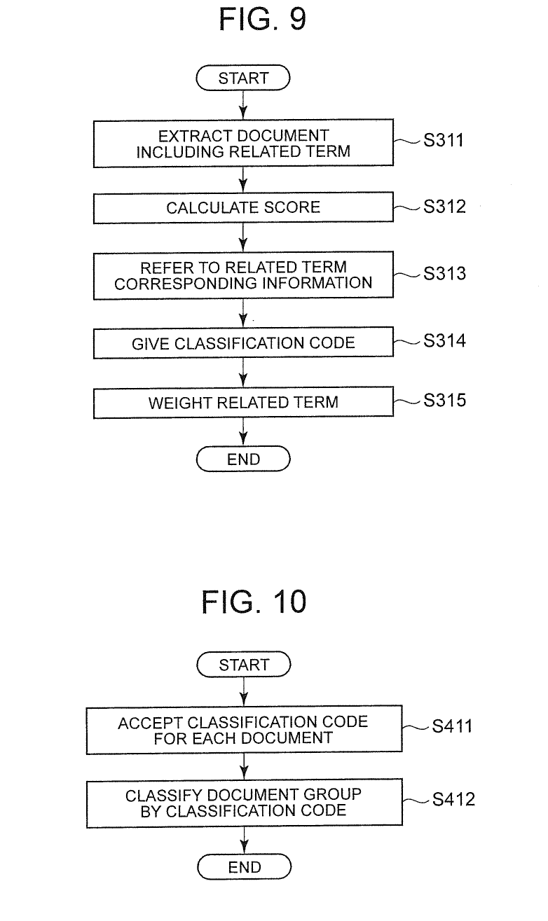

A detailed processing flow of the second automatic classification unit 301 in the third stage will be described with reference to FIG. 9.

In the example, the second automatic classification unit 301 performs processing to give classification codes as “product A” and “product B” to document information to which no classification code is given in the second stage (STEP 200).

The second automatic classification unit 301 extracts from the document information documents including the related terms “coding process,” “product a,” “decoding,” and “product b” recorded in the related term database 105 in the first stage (STEP 311). The score calculation unit 116 calculate a score for each of the extracted documents using the equation (1) based on the appearance frequencies and evaluation values of the recorded four related terms (STEP 312). The score represents the degree of relevance between each document and the classification codes “product A” and “product B.”

When the score exceeds a threshold value, the related term corresponding information is referred (STEP 313) to give an appropriate classification code (STEP 314).

For example, when the appearance frequencies of the related terms “coding process” and “product a,” and the evaluation value of the related term “coding process” are high in a certain document, and the score indicative of the degree of relevance to the classification code “product A” exceeds the threshold value, the classification code “product A” is given to the document.

At this time, when the appearance frequency of the related term “product b” is also high in the document and the score indicative of the degree of relevance to the classification code “product B” exceeds the threshold value, the “product B” is also given to the document together with the classification code “product A.” On the other hand, when the appearance frequency of the related term “product b” is low in the document and the score indicative of the degree of relevance to the classification code “product B” does not exceed the threshold value, only the classification code “product A” is given to the document.

The second automatic classification unit 301 recalculates the evaluation value of the related term according to equation (2) using the score calculated in STEP 432 of the fourth stage to weight the evaluation value (STEP 315):

wgt_{i,L}=\sqrt{wgt_{L-i}²+γ_{L},wgt_{i,L}²−θ}=\sqrt{wgt_{i,L}²+Σₗ₌₁^{L}(γ_{L}wgt_{i,j}²−θ)} (2)

Wgt_{i,0}: weighting of the i-th selected keyword before learning (default)
Wgt_{i,L}: weighting of the i-th selected keyword after the L-th learning
γ_{L}: learning parameter in the L-th learning
θ: threshold value for learning effect.

For example, when there are a certain number of documents in which the appearance frequency of “decoding” is very high but the score is lower than or equal to a certain value, the evaluation value of the related term “decoding” is lowered and recorded in the related term corresponding information again.

### Fourth Stage (STEP 400)

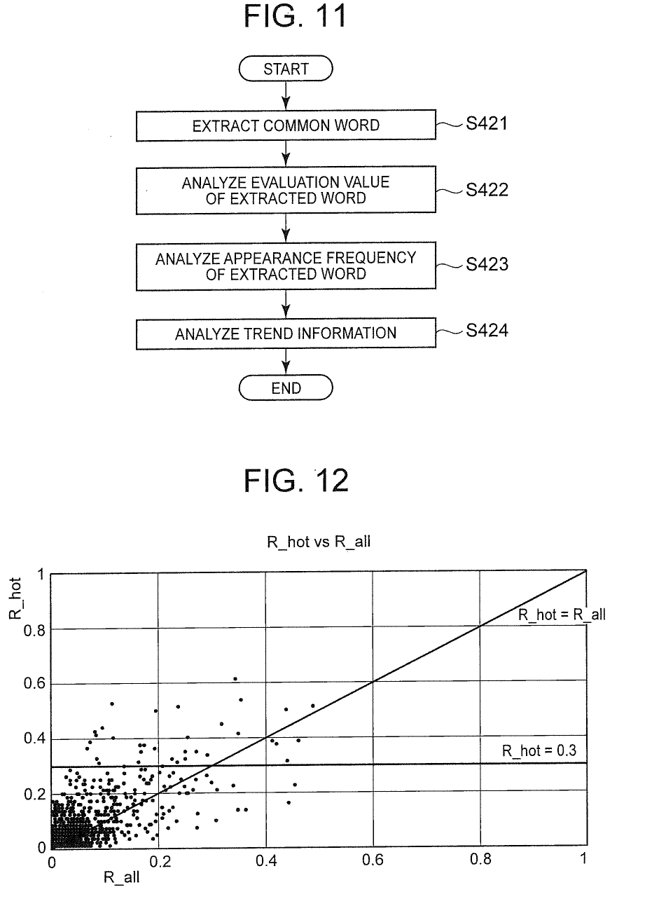

In the fourth stage, as shown in FIG. 10, classification coded given by the reviewer are accepted for a certain ratio of document information extracted from the document information to which no classification code is given in the processing up to and including the third stage to give the classification codes accepted for the document information. Next, as shown in FIG. 11, the document information to which the classification codes accepted from the reviewer are given is analyzed, and based on the analysis results, the classification codes are given to document information to which no classification code is given. In the example, processing to give classification codes, for example, “important,” “product A,” and “product B” to the document information is performed in the fourth stage. The following will further describe the fourth stage.

A detailed processing flow of the classification code accepting/giving unit 131 in the fourth stage will be described with reference to FIG. 10. The document extraction unit 112 first performs random sampling of documents from document information as the processing target in the fourth stage and displays the documents on the document display unit 130. In the example, 20 percent of document information to be processed is extracted at random as a classification target by the reviewer. The sampling may be done in such a manner that the documents are sorted by created date and time or by name, and 30 percent of documents from the top are selectively extracted.

The user views a display screen 11 displayed on the document display unit 130 as shown in FIG. 16 to select a classification code to be given to each document. The classification code accepting/giving unit 131 accepts the classification code selected by the user (STEP 411), and performs classification based on the classification code given (STEP 412).

Next, a detailed processing flow of the document analysis unit 118 will be described with reference to FIG. 11. The document analysis unit 118 extracts words appearing in common in documents classified by classification code by means of the classification code accepting/giving unit 131 (STEP 421). The evaluation values of the extracted common words are analyzed according to the equation (2) (STEP 422) to analyze the appearance frequencies of the common words in the documents (STEP 423).

Further, the trend information on documents to which the classification code “important” is given is analyzed based on the analysis results in STEP 422 and STEP 423 (STEP 424).

FIG. 12 is a graph of the analysis results of the words appearing in common in the documents to which the classification code “important” is given in STEP 424.

In FIG. 12, the ordinate R_hot includes words selected as words linked with the classification code “important” among all documents to which the classification code “important” is given by the user, indicating the ratio of the documents to which the classification code “important” is given. The abscissa indicates the ratio of documents including the words, extracted in STEP 421 by the classification code accepting/giving unit 131, to all the documents on which the classification processing has been performed by the user.

In the example, the classification code accepting/giving unit 131 extracts words plotted above a straight line R_hot=R_all as common words in the classification code “important.”

The processing in STEP 421 to STEP 424 is also performed on documents to which the classification codes “product A” and “product B” are given to analyze the trend information on the documents.

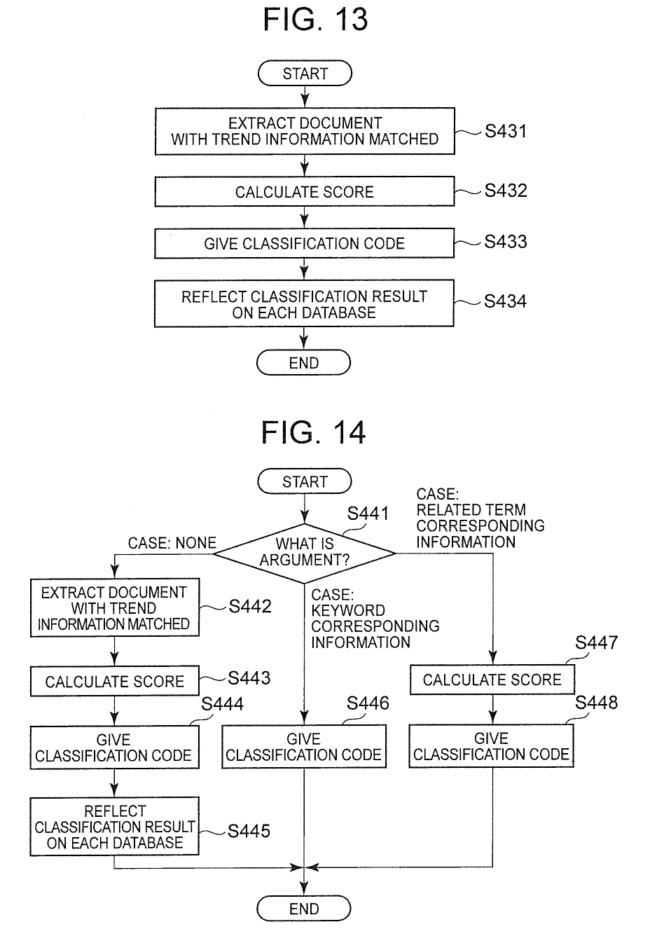

Next, a detailed processing flow of the third automatic classification unit 401 will be described with reference to FIG. 13. The third automatic classification unit 401 performs processing of documents the giving of classification codes of which has not been accepted by the classification code accepting/giving unit 131 in STEP 411 among document information as the processing target in the fourth stage. The third automatic classification unit 401 extracts from these documents documents having the same trend information as the trend information on the documents analyzed in STEP 424 to be given the classification codes “important,” “product A,” and “product B” (STEP 431) to calculate a score for each of the extracted documents using the equation (1) based on the trend information (STEP 432). Further, third automatic classification unit 401 gives an appropriate classification code to the document extracted in STEP 431 based on the trend information (STEP 433).

The third automatic classification unit 401 further uses the score calculated in STEP 432 to reflect the classification results on each database (STEP 434). Specifically, processing to lower the evaluation values of the keywords and the related terms included in documents the scores of which are low, and raising the evaluation values of the keywords and the related terms included in documents the scores of which are high may be performed.

Further, one example of the detailed processing flow of the third automatic classification unit 401 will be described with reference to FIG. 14. The third automatic classification unit 401 may perform classification processing of documents the giving of classification codes of which has not been accepted by the classification code accepting/giving unit 131 in STEP 411 among document information as the processing target in the fourth stage. When no argument is given (STEP 441: None), the third automatic classification unit 401 extracts from the documents documents having the same trend information as the trend information on the documents analyzed in STEP 424 to be given the classification code “important” (STEP 442) to calculate a score for each of the extracted documents using the equation (1) based on the trend information (STEP 443). Further, the third automatic classification unit 401 gives an appropriate classification code to the document extracted in STEP 442 based on the trend information (STEP 444).

The third automatic classification unit 401 further uses the score calculated in STEP 443 to reflect the classification results on each database (STEP 445). Specifically, processing to lower the evaluation values of the keywords and the related terms included in documents the scores of which are low, and raising the evaluation values of the keywords and the related terms included in documents the scores of which are high is performed.

As mentioned above, both the second automatic classification unit 301 and the third automatic classification unit 401 calculate scores. When the number of score calculations increases, data for score calculations may be collectively stored in the score calculation database 106.

### Fifth Stage (STEP 500)

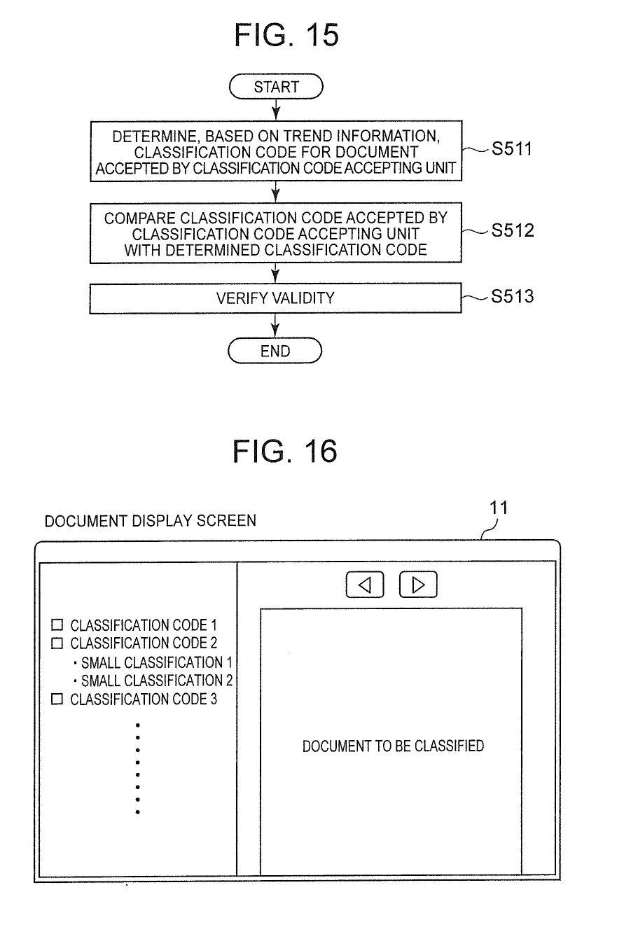

A detailed processing flow of the quality checking unit 501 in the fifth stage will be described with reference to FIG. 15. Based on the trend information analyzed by the document analysis unit 118 in STEP 424, the quality checking unit 501 determines classification codes to be given to the documents accepted by the classification code accepting/giving unit 131 in STEP 411 (STEP 511).

The quality checking unit 501 compares the classification codes accepted by the classification code accepting/giving unit 131 and the classification codes determined in STEP 511 (STEP 512) to verify the validity of the classification codes accepted in STEP 411 (STEP 513).

The document analysis system 1 may include the learning unit 601. Based on the first to fourth processing results, the learning unit 601 learns the weighting of each keyword or related term according to equation (2). The learning results may be reflected on the keyword database 104, the related term database 105, or the score calculation database 106.

The document analysis system can include the report preparation unit 701 to output an optimal investigative report based on the results of the document analysis processing according to the type of investigation such as litigation matters (for example, cartel, patent, FCPA, or PL if it is litigation) or fraud investigation (for example, information leak, billing fraud, or the like).

The content of investigation differs depending on the type of investigation.

For example, in a cartel matter, the key points are:

1. When and how did a person in charge perform communication (adjustment of prices) related to a cartel?

2. Who is the person involved and to what organization is the person belongs?

In a patent infringement, the key points are:

1. Is the content the same as technology as an infringement target?

2. Who did or did not infringe, when, and with what intention (or without what intention)?

Another example will be described below.

In another example, a method of analyzing documents to which classification codes have already been given in response to similar search information to adjust a range of giving the classification codes based on the analysis results is employed.

As methods of adjusting the range of giving classification codes in response to the similar search information, there are a method of clustering similar search information in response to the similar search information to adjust the range of giving the classification codes and a method of learning the classification results to perform predictive classification. For example, in the method of clustering similar search information in response to the similar search information to adjust the range of giving the classification codes, there is a case where attention on commonality between pieces of metadata is focused to give a common classification code to an original document, a reply document to the original document, and a reply document to the reply document to the original document. In the method of learning the classification results to perform predictive classification, the classification results are learned to integrate similar search information to give the same or a similar classification code to the similar search information.

In still another example, reliability of the analysis results varies depending on the number of documents to be analyzed. A statistical technique may be added to the total number of documents to be classified to define at what point and in what ratio to all the documents a range of giving classification codes is adjusted based on the analysis results.

In yet another example, as the method of adjusting the range of giving the classification codes in response to similar search information, both the method of clustering search information in response to similar search information to adjust the range of giving the classification codes and the method of learning the classification results to perform predictive classification may be executed to adjust the range of giving the classification codes. This can not only give exact classification codes promptly in the other example of the embodiment of the present invention, but also reduce the burden associated with classification work.

The document analysis program is a document analysis program to acquire digital information recorded on multiple computers or servers, and analyze document information included in the acquired digital information and composed of multiple documents to make easy use of the document information in litigation or fraud investigation, characterized by causing a computer to realize: an input-of-investigation category accepting function of accepting the input of a category of litigation or fraud investigation; and an investigation type determining function of determining an investigation category as an investigation target based on the category accepted by the input-of-investigation category accepting function to extract the type of necessary information from an investigation basic database for storing information related to the litigation or fraud investigation.

The input-of-investigation category accepting function can be implemented by the input-of-investigation category accepting unit. The details are as described above.

The investigation type determining function can be implemented by the investigation type determining unit. The details are as described above.

The example accepts user's input about a category of a litigation matter or a fraud investigation matter to update a database automatically according to the category. This reduces the burden of clerical work to enter the names of a person in charge and a custodian and the like. Further, a search term is adjusted by the database automatically updated according to the category to give classification codes automatically to the document information using the adjusted search term. This reduces the burden of classification work for document information used in litigation or fraud investigation.

In other words, our systems, programs and methods make it easy to analyze document information used in a lawsuit.

1.-8. (canceled)

9. A document analysis system that acquires digital information recorded on a plurality of computers or servers, and analyzing document information included in the acquired digital information and composed of a plurality of documents to make easy use of the document information in litigation or fraud investigation, comprising:
an investigation basic database that stores information related to the litigation or fraud investigation;
an input-of-investigation category accepting unit that accepts input of a category of the litigation or fraud investigation; and
an investigation type determining unit that determines an investigation category as an investigation target based on the category accepted by the input-of-investigation category accepting unit to extract a type of necessary information from the investigation basic database.

10. The document analysis system according to claim 9, further comprising a display screen controlling unit that controls a display screen to present, to a user, the type of information extracted by the investigation type determining unit.

11. The document analysis system according to claim 10, further comprising an input accepting unit that accepts user's input of a keyword and/or a sentence corresponding to the type of information presented to the display screen controlling unit.

12. The document analysis system according to claim 9, further comprising an information extraction unit that extracts, from the investigation basic database a keyword and/or a sentence corresponding to the type of information extracted by the investigation type determining unit.

13. The document analysis system according to claim 11, further comprising a search unit that searches the documents for the keyword and/or the sentence.

14. The document analysis system according to claim 11, further comprising an automatic classification code giving unit that automatically gives classification codes to the documents, wherein the keyword and/or the sentence are used to give the classification codes.

15. A method of analyzing documents to acquire digital information recorded on a plurality of computers or servers, and analyze document information included in the acquired digital information and composed of a plurality of documents to make easy use of the document information in litigation or fraud investigation, comprising:
an input-of-investigation category accepting step of accepting input of a category of the litigation or fraud investigation; and
an investigation type determining step of determining an investigation category as an investigation target based on the category accepted in the input-of-investigation category accepting step to extract a type of necessary information from an investigation basic database for storing information related to the litigation or fraud investigation.

16. A non-transiting computer readable storage media that acquires digital information recorded on a plurality of computers or servers, and analyzes document information included in the acquired digital information and composed of a plurality of documents to make easy use of the document information in litigation or fraud investigation, the program causing a computer to realize:
an input-of-investigation category accepting function of accepting input of a category of the litigation or fraud investigation; and
an investigation type determining function of determining an investigation category as an investigation target based on the category accepted by the input-of-investigation category accepting function to extract a type of necessary information from an investigation basic database for storing information related to the litigation or fraud investigation.

17. The document analysis system according to claim 12, further comprising a search unit that searches the documents for the keyword and/or the sentence.

18. The document analysis system according to claim 12, further comprising an automatic classification code giving unit that automatically gives classification codes to the documents, wherein the keyword and/or the sentence are used to give the classification codes.

19. The document analysis system according to claim 13, further comprising an automatic classification code giving unit that automatically gives classification codes to the documents, wherein the keyword and/or the sentence are used to give the classification codes.
